(19) United States
(12) Patent Application Publication
(10) Pub. No.: US 2025/0200482 A1
(43) Pub. Date: Jun. 19, 2025

(54) WORK ANALYZING DEVICE AND WORK ANALYZING METHOD

(71) Applicant: Panasonic Intellectual Property Management Co., Ltd., Osaka (JP)

(72) Inventor: Tatsuya ISHIBASHI, Kanagawa (JP)

(73) Assignee: Panasonic Intellectual Property Management Co., Ltd., Osaka (JP)

(21) Appl. No.: 18/846,930

(22) PCT Filed: Feb. 28, 2023
(86) PCT No.: PCT/JP2023/007347

§ 371 Date: Sep. 13, 2024

(30) Foreign Application Priority Data
Mar. 22, 2022 (JP) 2022-045872

(51) Int. Cl. G06Q 10/0639; G06V 10/764; G06V 40/20

(52) U.S. Cl. CPC G06Q 10/0639; G06V 10/764; G06V 40/28

(57) ABSTRACT

Provided is a system configured to analyze and visualize a worker's actions forming a work in association with an object handled by the worker such as a component or a work tool, thereby enabling a user to easily grasp a work performance status of the worker in detail. The system recognizes types of objects handled by the worker, while recognizing types of the worker's actions associated with each object; and outputs, as a visualized analysis result, a time series representation of a status of the actions associated with each object. Specifically, action fields extending along a horizontal time axis are provided in a row for respective types of objects. Shown in each action field is action bars, each of which extends horizontally to a length representing a time period during which a corresponding action is performed.

### TECHNICAL FIELD

The present disclosure relates to a work analyzing device and a work analyzing method in which a processor is caused to perform operations to output analysis result information on a work performance status of a worker based on video recordings of actions of the worker.

### BACKGROUND ART

In factories, operation efficiency can be improved by analyzing work performance statuses of workers and changing operating procedures or other methods of work based on results of the analysis. For this reason, there is a need for technologies for analyzing work performance statuses of workers in an efficient manner. Furthermore, there is a need for technologies for presenting analysis result information on a work performance status of a worker to a user in an easy-to-understand manner.

Known such technologies for analyzing a work performance status of a worker include a method which involves capturing video recordings of actions of a worker with a camera; analyzing, from the video recordings, a work performance status of a worker; and presenting to a user a Gantt chart that visualizes a status of the worker's actions in each process step and/or a video image of the working worker during work (Patent Document 1).

### PRIOR ART DOCUMENT(S)

### Patent Document(s)

Patent Document 1: JP2019-16226A

### SUMMARY OF THE INVENTION

Task to be Accomplished by the Invention

The above-described prior art allows a user to relatively easily grasp a work performance status of a worker in each process step by viewing and comparing a Gantt chart with a video image. However, there is a need for technologies for visualizing a work performance status of a worker not in units of prescribed work steps, but in units of actions that form each work step. For example, in an assembly process, in which a worker holds components (parts) or uses work tools, when there is a system that allows a user to grasp what actions the worker has performed in association with each of the components and work tools handled by the worker, the user would easily grasp a work performance status of the worker in more detail. However, systems of the prior art do not satisfy such needs.

The present disclosure has been made in view of the problem of the prior art, and a primary object of the present disclosure is to provide a work analyzing device and a work analyzing method for analyzing and visualizing a worker's actions forming a work, in association with an object handled by the worker such as a component or a work tool, thereby enabling a user to easily grasp a work performance status of the worker in more detail.

### Means to Accomplish the Task

An aspect of the present disclosure provides a work analyzing device in which a processor is caused to perform operations to output analysis result information on a work performance status of a worker based on video recordings of actions of the worker, wherein the processor is configured to: based on the video recordings, recognize one or more target objects to be handled by the worker and determine types of the target objects, while recognizing one or more actions of the worker, the actions forming a work, and determining types of the actions; and output analysis result display information which visualizes the analysis result information, and is a time series representation of a status of the actions associated with each of the types of the target objects.

Another aspect of the present disclosure provides a work analyzing method for causing a processor to perform operations to output analysis result information on a work performance status of a worker based on video recordings of actions of the worker, the operations comprising: based on the video recordings, recognizing one or more objects to be handled by the worker and determining types of the target recognized objects, while recognizing one or more actions of the worker, the actions forming a work, and determining types of the actions; and outputting analysis result display information which visualizes the analysis result information, and is a time series representation of a status of the actions associated with each of the types of the objects.

### Effect of the Invention

According to the present disclosure, operations are performed to analyze and visualize a worker's actions forming a work, in association with an object (a target object) handled by the worker such as a component or a work tool, thereby enabling a user to easily grasp a work performance status of the worker in more detail.

### BRIEF DESCRIPTION OF THE DRAWINGS

FIG. 1 is a diagram showing an overall configuration of a work analyzing system according to an embodiment of the present disclosure;

FIG. 2 is a block diagram showing a schematic configuration of a server;

FIG. 3 is a block diagram showing an outline of an analysis operation performed by the server;

FIG. 4 is an explanatory diagram showing situations when a work cycle detection operation is performed by the server;

FIG. 5 is a block diagram showing an outline of an analysis result visualization operation performed by the server;

FIG. 6 is an explanatory diagram showing an analysis result display screen displayed on an administrator terminal;

FIG. 7 is an explanatory diagram showing the analysis result display screen including a process selection section, a period designation section, a video image display section, a playback menu section, and a work cycle selection section;

FIG. 8 is an explanatory diagram showing an analysis result details section in the analysis result display screen;

FIG. 9 is an explanatory diagram showing relevant parts of an analysis result details section in the analysis result display screen when a work mistake (abnormality) occurs;

FIG. 10 is an explanatory diagram showing relevant parts of the analysis result details section in the analysis result display screen when a work mistake (abnormality) occurs;

FIG. 11 is an explanatory diagram showing another example of the analysis result details section;

FIG. 12 is an explanatory diagram showing an overall analysis result section in the analysis result display screen; and

FIG. 13 is an explanatory diagram showing another example of the overall analysis result section.

### DESCRIPTION OF THE PREFERRED EMBODIMENT(S)

A first aspect of the present disclosure made to achieve the above-described object is a work analyzing device in which a processor is caused to perform operations to output analysis result information on a work performance status of a worker based on video recordings of actions of the worker, wherein the processor is configured to: based on the video recordings, recognize one or more target objects to be handled by the worker and determine types of the target objects, while recognizing one or more actions of the worker, the actions forming a work, and determining types of the actions; and output analysis result display information which visualizes the analysis result information, and is a time series representation of a status of the actions associated with each of the types of the target objects.

According to this configuration, the processor performs operations to analyze and visualize a worker's actions forming a work, in association with an object (a target object) handled by the worker such as a component or a work tool, thereby enabling a user to easily grasp a work performance status of the worker in more detail.

A second aspect of the present disclosure is the work analyzing device of the first aspect, wherein the processor outputs the video recordings as a video image that allows for playback, in association with the analysis result display information.

In this configuration, a user is allowed to easily grasp a work performance status of a worker by viewing and comparing the analysis result display information with a video image. In this configuration, for example, a timeline cursor indicating a current playback position may be included in the analysis result display information displayed on the screen.

A third aspect of the present disclosure is the work analyzing device of the first aspect, wherein the processor identifies at least one of a component or a work tool as the type of the target objects.

This configuration enables a user to identify the type of components and work tools as target objects, thereby acquiring more appropriate analysis result information.

A fourth aspect of the present disclosure is the work analyzing device of the third aspect, wherein the processor identifies at least one of an action of holding a component and an action of using a work took as the type of the actions of the worker.

This configuration enables a user to distinguishably identify an action of holding a component and an action of using a work tool, thereby acquiring more appropriate analysis result information.

A fifth aspect of the present disclosure is the work analyzing device of the first aspect, wherein, when detecting an abnormality in the work performance status of the worker, the processor outputs the analysis result display information that includes information on the detected abnormality.

This configuration enables a user to easily recognize an abnormality in the work performance status. In one example, the device may be configured to detect abnormalities in a work cycle consisting of a set of actions, the abnormalities being related to e.g., an excess or deficiency of actions, the order of actions, and the period of time of a work cycle.

A sixth aspect of the present disclosure is the work analyzing device of the fifth aspect, wherein the analysis result display information includes, as the information on the detected abnormality, at least one of a highlighted display of fields for the recognized target objects, a display of a mark indicating a corresponding one of the actions associated with the abnormality, a display of a text indicating the detected abnormality, and a display of statistical information including a set of statistics collected over a prescribed period of time included in a period of time designated for the analysis result information.

This configuration enables a user to more easily recognize an abnormality in the work performance status. In this configuration, the device may display a result of abnormality detection in units of actions, thereby enabling a user to check details of a situation related to the detected abnormality. In some cases, the device may display statistical information including a set of statistics collected over a prescribed period of time, thereby enabling a user to easily check a situation related to the detected abnormality. In such a case, for example, the device may count the detection of abnormalities in each work cycle and display the number of times of detection of abnormalities for each work cycle.

A seventh aspect of the present disclosure is a work analyzing method for causing a processor to perform operations to output analysis result information on a work performance status of a worker based on video recordings of actions of the worker, the operations comprising: based on the video recordings, recognizing one or more objects to be handled by the worker and determining types of the target recognized objects, while recognizing one or more actions of the worker, the actions forming a work, and determining types of the actions; and outputting analysis result display information which visualizes the analysis result information, and is a time series representation of a status of the actions associated with each of the types of the objects.

In this configuration, operations are performed to analyze and visualize actions of a worker's actions forming a work, in association with an object (a target object) handled by the worker such as a component or a work tool, which enables a user to easily grasp a work performance status of the worker in more detail, as in the first aspect.

Embodiments of the present disclosure will be described below with reference to the drawings.

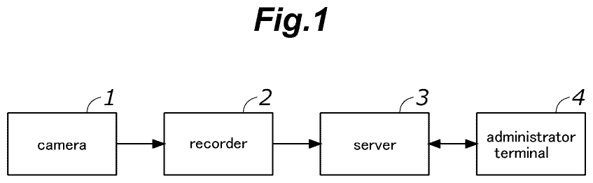

FIG. 1 is a diagram showing an overall configuration of a work analyzing system according to an embodiment of the present disclosure.

The work analyzing system is configured to analyze a work performance status of a worker in a workplace such as a factory to thereby present a result of analysis to a user. The system includes a camera 1, a recorder 2, a server 3 (work analyzing device), and an administrator terminal 4.

The camera 1 images a worker working at the worker's place.

The recorder 2 records video data provided from the camera 1.

The server 3 acquires video recordings from the camera 1 and/or the recorder 2, analyzes a work performance status of a worker based on video recordings, and outputs a result of the analysis. The server 3 is installed in a facility (e.g., a factory) and performs work analysis for the facility. The server 3 may also be configured as a cloud computer and perform work analysis for a plurality of facilities.

The administrator terminal 4 is used by a system administrator or a work administrator (user), and is implemented by a PC, a tablet terminal, or any other suitable device. The system administrator uses the administrator terminal 4 to perform settings for various operations performed by the server 3. In addition, the administrator terminal 4 displays results of analysis provided from the server 3 so that the work administrator can view the results.

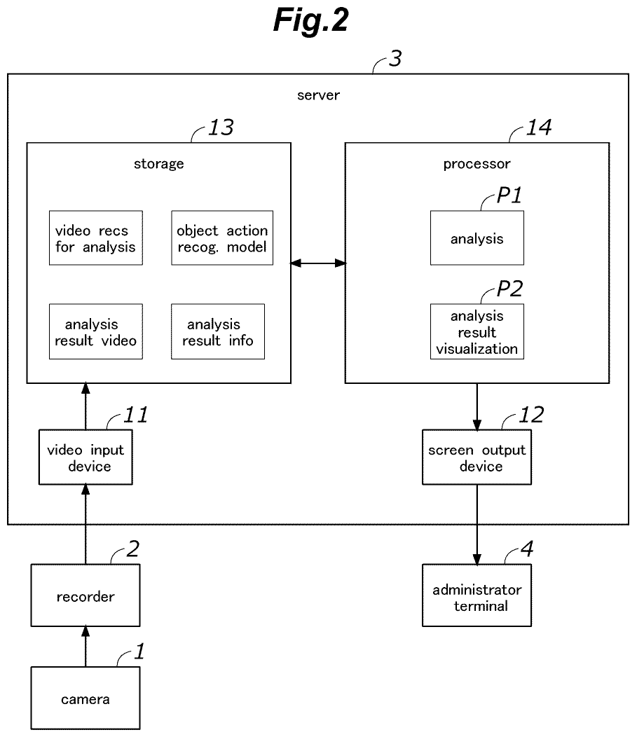

Next, a schematic configuration of the server 3 will be described. FIG. 2 is a block diagram showing a schematic configuration of the server 3.

The server 3 includes a video input device 11, a screen output device 12, a storage 13, and a processor 14.

The video input device 11 receives at video recordings recorded in the recorder 2.

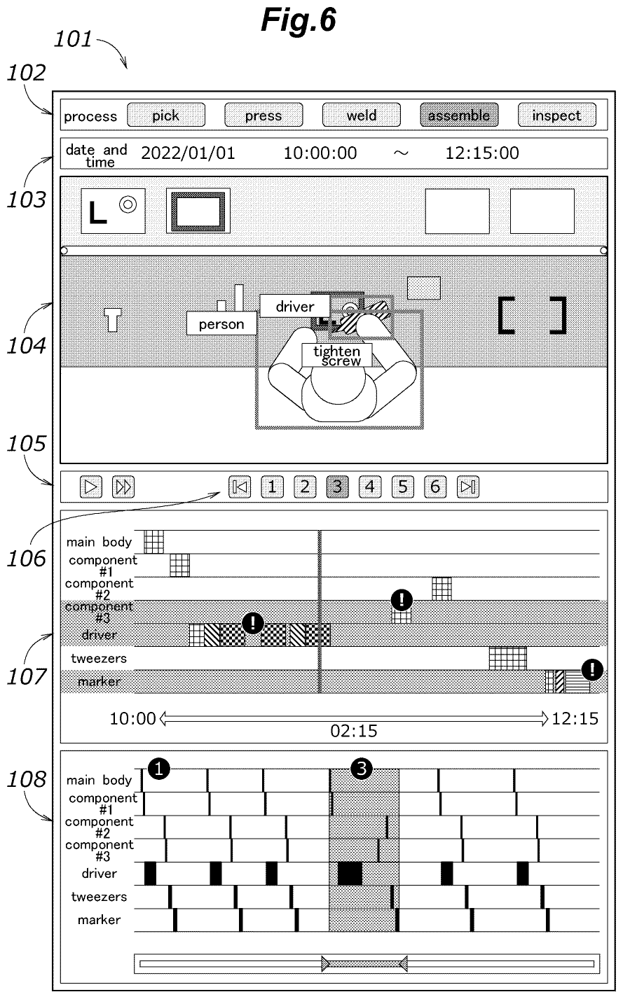

The screen output device 12 outputs data of an analysis result display screen generated by the processor 14, and the analysis result display screen (FIG. 6) is displayed on the administrator terminal 4.

The storage 13 stores programs which are executable by a processor 14 and other data. The storage 13 stores video recordings for analysis acquired from the recorder 2. The storage 13 stores an object action recognition model (object action estimation model) to be used by the processor 14, as well as an analysis result video and analysis result information generated by the processor 14.

The processor 14 performs various operations by executing programs stored in the storage 13. In the present embodiment, the processor 14 performs an analysis operation P1, an analysis result visualization operation P2, and other operations.

In the analysis operation P1, the processor 14 makes analysis of a work performance status of a worker based on video recordings of actions of the worker to generate analysis result information.

In the analysis result visualization operation P2, the processor 14 visualizes the analysis result information generated in the analysis operation P1 and presents the visualized information to a user. In the present embodiment, the processor 14 generates an analysis result display screen (FIG. 6).

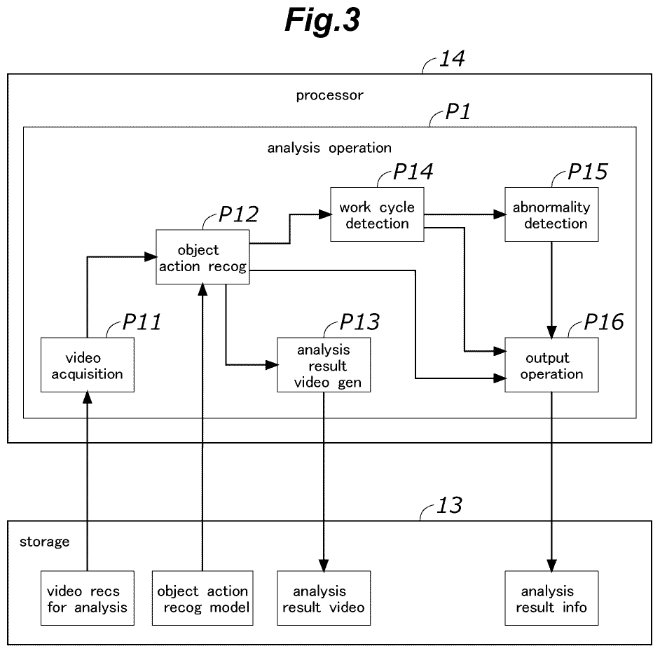

Next, the analysis operation P1 performed by the server 3 will be described. FIG. 3 is a block diagram showing an outline of the analysis operation P1 performed by the server 3.

In the server 3, the processor 14 performs an analysis operation P1. The analysis operation P1 includes a video acquisition operation P11, an object action recognition operation P12, an analysis result video generation operation P13, a work cycle detection operation P14, an abnormality detection operation P15, and an output operation P16.

In the video acquisition operation P11, the processor 14 acquires video recordings to be analyzed from the storage 13.

In the object action recognition operation P12, the processor 14 performs an object recognition to recognize the type of each object (person, component, and work tool) from video recordings to be analyzed, and an action recognition (action estimation) to recognize the type of a person's action. In the action recognition, the action of a person is recognized based on the movement of the person and the type of object which the person touches. In the object action recognition operation P12, the processor 14 acquires recognition result information including the action ID assigned to an action, the type of a target object, and the start and end times of the action. In the object action recognition operation P12, the processor may use an object action recognition model (machine learning model) constructed by machine learning technology such as deep learning technology.

In the analysis result video generation operation P13, the processor 14 generates an analysis result video including recognition result information. Specifically, the processor 14 generates a rectangular frame surrounding the object (person, component, or work tool) recognized in the object action recognition operation P12, a text indicating the type of the recognized object, and a text indicating the type of recognized action, and then the processor 14 overlays the generated recognition result information on an original video image (i.e., video recordings to be analyzed) to thereby generate an analysis result video.

In the work cycle detection operation P14, the processor 14 detects a work cycle (prescribed period of time), the work cycle consisting of a predetermined series of actions, from the worker's actions recognized in the object action recognition operation P12. In the work cycle detection operation P14, the processor 14 acquires detection result information (work cycle information) including the action ID assigned to a work cycle, and the start and end times of the work cycle.

In the abnormality detection operation P15, the processor 14 detects work mistakes (abnormalities in actions) by comparing a worker's work procedure (series of actions of the worker) with a regular work procedure. Specifically, the processor 14 detects a work mistake by comparing the actions performed by the worker in a work cycle with actions included in the regular work procedure. Examples of work mistakes include an excess of actions, a deficiency of actions, and a change in the order of actions. An excess of actions occurs in the case where a worker performs an extra action when it should not have been performed. A deficiency of action occurs in the case where a worker fails to perform an action when it should be performed.

Furthermore, in the abnormality detection operation P15, the processor 14 compares a worker's work time for one work cycle with a standard time, to thereby detect an abnormality in the work cycle. Specifically, the processor 14 determines that a work cycle is abnormal when the time of the work cycle is longer than the standard time by a predetermined limit of time. This abnormality occurs, for example, when a production line is temporarily stopped due to some trouble. Also, the processor 14 determines that a work cycle is abnormal when the time of the work cycle is shorter than the standard time, which occurs for example, in a case that a work cycle is canceled in the middle of the cycle.

In the output operation P16, the processor 14 outputs analysis result information including action-related information (e.g., type of action, start time, end time) acquired in the object action recognition operation P12, work-cycle-related information (e.g., start time, end time) acquired in the work cycle detection operation P14, and detection result information (abnormalities in actions (work mistakes), abnormalities in work cycles) acquired in the abnormality detection operation P15. The analysis result information is stored in the storage 13.

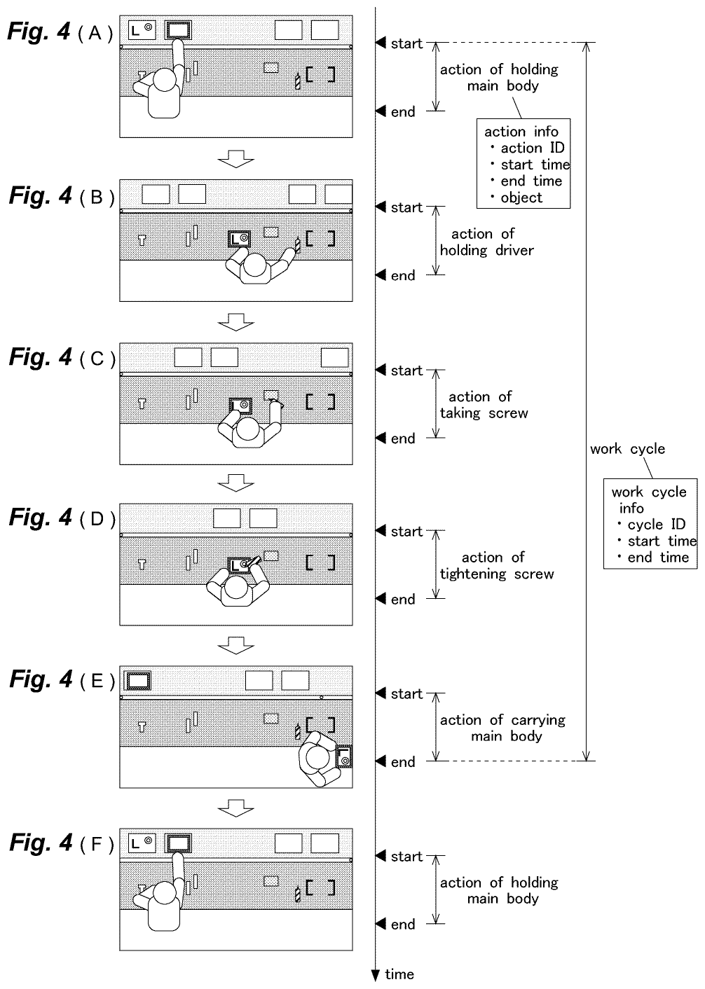

Next, the work cycle detection operation P14 performed by the server 3 will be described. FIG. 4 is an explanatory diagram showing situations when the work cycle detection operation P14 is performed.

In the server 3, the processor 14 performs the work cycle detection operation P14 to detect a work cycle consisting of a predetermined series of actions. Specifically, the processor 14 detects a trigger action, occurrence of which defines a start time of a work cycle, in the recognized actions, sets the time of detection of the trigger action as a start time of a work cycle, and sets the time of detection of an action immediately before the next trigger action as an end time of the work cycle.

FIG. 4 shows an example of set of actions included in one work cycle. In this example, first, as shown in FIG. 4(A), a worker performs an action of holding a component, which is a main body, by hand. Next, as shown in FIG. 4(B), the worker performs an action of holding a screwdriver by hand. Next, as shown in FIG. 4(C), the worker performs an action of picking a screw from a parts box. Next, as shown in FIG. 4(D), the worker performs an action of turning and tightening the screw. Next, as shown in FIG. 4(E), the worker performs an action of carrying the main body. Next, as shown in FIG. 4(F), the worker performs an action of holding the main body by hand.

As shown in FIGS. 4(A) and 4(F), the worker's action of holding the main body by hand is used as a trigger action, occurrence of which defines a start time of a work cycle. The time of completion of an action immediately before the next trigger action is set to be an end time of the work cycle.

The processor 14 acquires, as recognition result information on each recognized action, action information including the action ID assigned to the action, the type of an object associated with the action (target object), and the start time and end time of the action. The processor 14 also acquires, as work cycle detection result information, work cycle information including the cycle ID assigned to a work cycle, and the start time and end time of the work cycle.

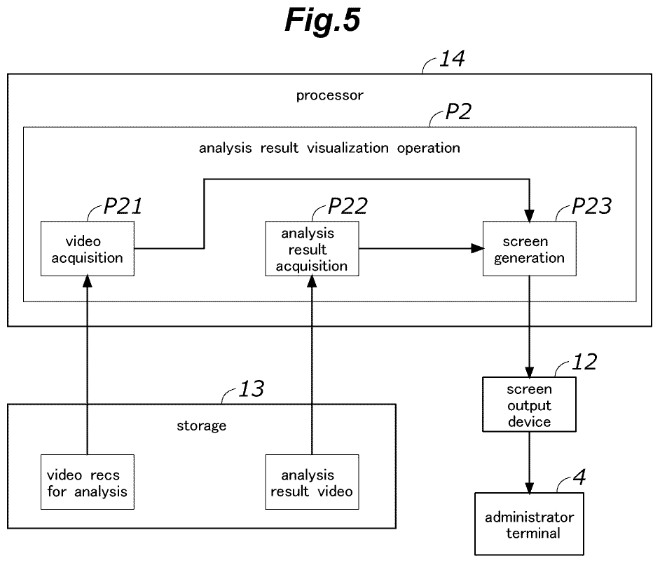

Next, the analysis result visualization operation P2 performed by the server 3 will be described. FIG. 5 is a block diagram showing an outline of the analysis result visualization operation P2.

In the server 3, the processor 14 performs the analysis result visualization operation P2. The analysis result visualization operation P2 includes a video acquisition operation P21, an analysis result acquisition operation P22, and a screen generation operation P23.

In the video acquisition operation P21, the processor 14 acquires analysis result video data from the storage 13. The analysis result video includes a rectangular frame surrounding a recognized object(s) (person, component, or work tool), a text indicating the type of the recognized object(s), and a text indicating the type of the recognized action, which are overlaid on an original video image (i.e., video recordings to be analyzed).

In the analysis result acquisition operation P22, the processor 14 acquires analysis result information from the storage 13. The analysis result information includes action-related information (such as the type, and the start time and end time of an action), work-cycle-related information (such as the start time and end time a work cycle), and abnormality detection result information (such as abnormalities in actions (work mistakes) and abnormalities in work cycles).

In the screen generation operation P23, the processor 14 generates an analysis result display screen (FIG. 6) that visualizes the analysis result information. Analysis result display screen data is output from the screen output device 12 to the administrator terminal 4, and the analysis result display screen is displayed on the administrator terminal 4. The analysis result display screen displays the analysis result video as well as the visualized analysis result information.

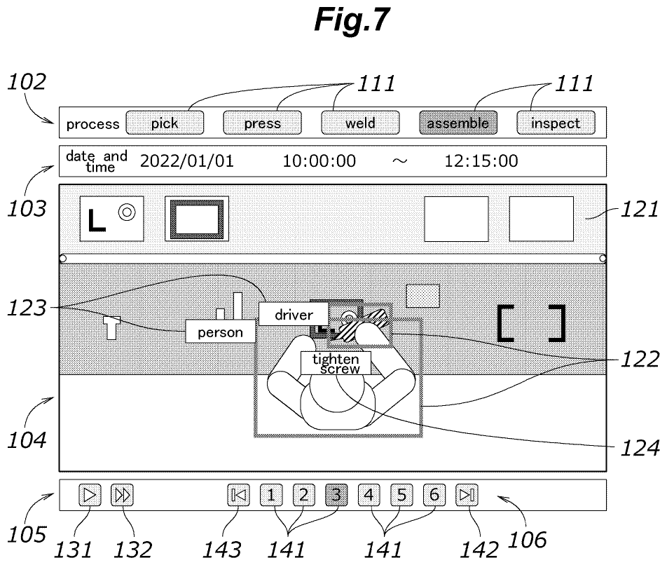

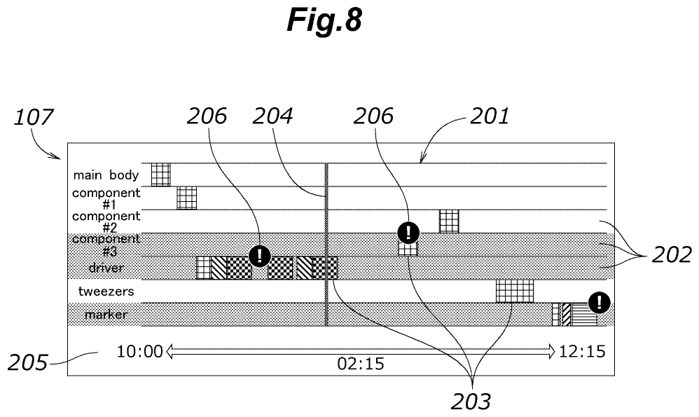

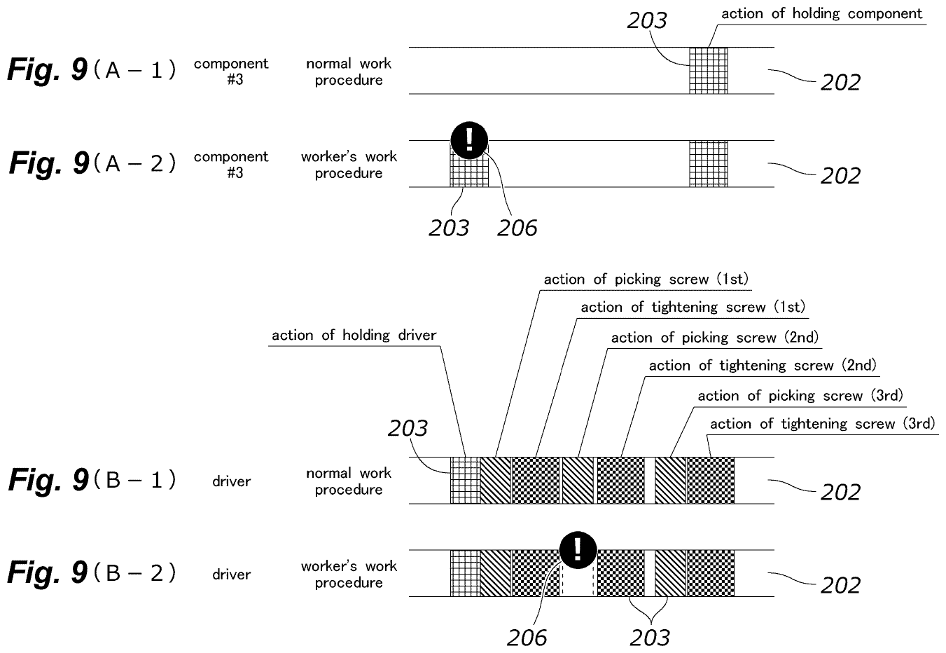

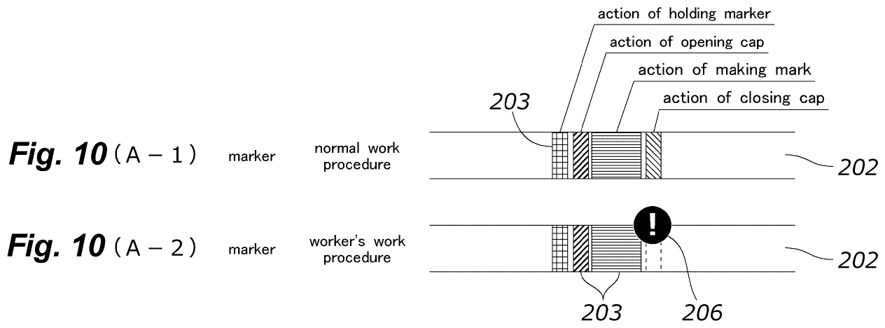

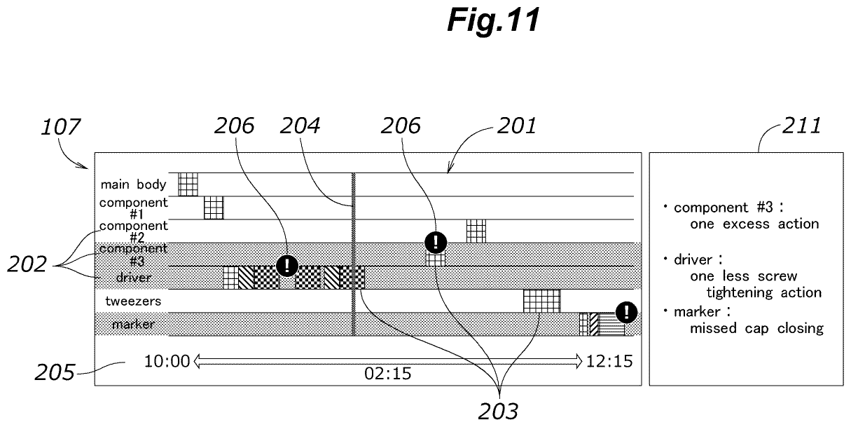

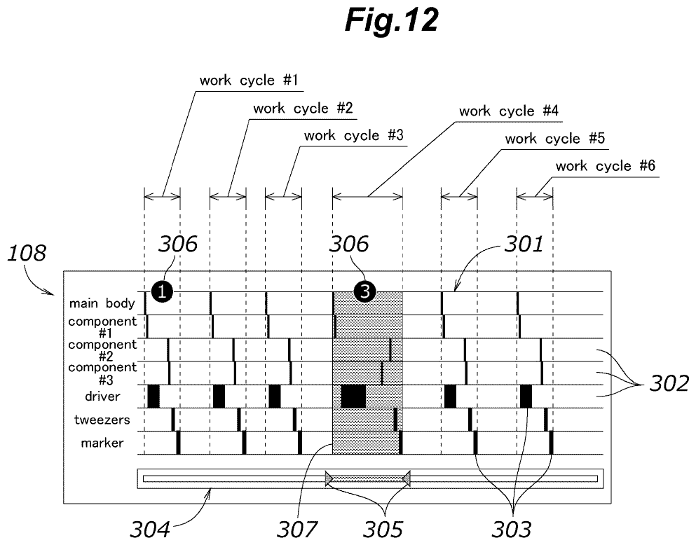

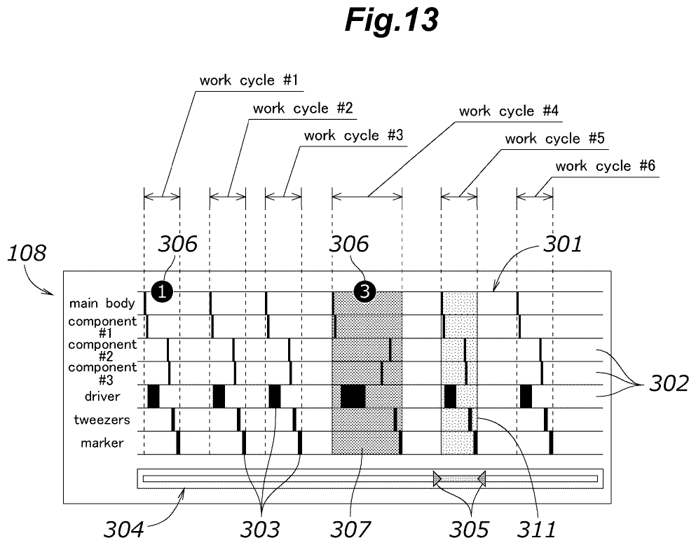

Next, an analysis result display screen displayed on the administrator terminal 4 will be described. FIG. 6 is an explanatory diagram showing an analysis result display screen. FIG. 7 is an explanatory diagram showing a process selection section 102, a period designation section 103, a video image display section 104, a playback menu section 105, and a work cycle selection section 106. FIG. 8 is an explanatory diagram showing an analysis result details section 107 in the analysis result display screen. FIGS. 9 and 10 are explanatory diagrams each showing relevant parts of the analysis result details section 107 when a work mistake (abnormality) occurs. FIG. 11 is an explanatory diagram showing another example of the analysis result details section. FIG. 12 is an explanatory diagram showing an overall analysis result section 108 in the analysis result display screen. FIG. 13 is an explanatory diagram showing another example of the overall analysis result section 108.

As shown in FIG. 6, the administrator terminal 4 displays the analysis result display screen 101. The analysis result display screen 101 includes a process selection section 102, a period designation section 103, a video image display section 104, a playback menu section 105, a work cycle selection section 106, an analysis result details section 107 (second section for displaying analysis result display information), and an overall analysis result section 108 (first section for displaying analysis result display information).

As shown in FIG. 7, the process selection section 102 has buttons 111 for each process step (picking, pressing, welding, assembling, and inspecting). When a user selects one of the process steps by operating a corresponding button 111, the analysis result display screen 101 displays analysis results for the selected process step.

The period designation section 103 allows a user to enter a date and time (start time and end time) in character format as information on a target period of time (first period) for which analysis results are displayed. The user is allowed to operate the period designation section 103 to designate any period of time included in an entire period of time during which video data was stored in the recorder 2 (i.e., a period of time for which work analysis results can be acquired based on the video data).

The video image display section 104 displays the analysis result video 121. The analysis result video 121 shows a video image of actions of a worker with signs and texts overlaid thereon, which include a rectangular frame 122 surrounding a recognized object (person, component, or work tool), a text 123 representing the type of a recognized object, and a text 124 representing the type of a recognized action. In this example, the analysis result video 121 displays a rectangular frame 122 and a text 123 representing a person (worker), a rectangular frame 122 and a text 123 representing a driver, and a text 124 representing the worker's action of turning and tightening a screw.

The playback menu section 105 has a playback/pause button 131, and a double speed button 132.

The work cycle selection section 106 has work cycle buttons 141 for corresponding work cycles (1-6), a skip backward button 142, and a skip forward button 143. When a user selects a work cycle by operating a work cycle button 141, analysis results for the selected work cycle are displayed in the video image display section 104 and the analysis result details section 107. When a user operates the skip backward button 142, the user can move to the start of a next work cycle. When a user operates the skip forward button 143, the user can return to the start of the currently displayed work cycle.

As shown in FIG. 8, the analysis result details section 107 has a first action list display section 201. The first action list display section 201 visualizes results of short-term analysis of statuses of the actions associated with the respective objects to present the visualized results to the user. In the first action list display section 201, action fields 202 extending horizontally are provided in a row for respective types of objects associated with actions of a worker. In this example, the action fields 202 are provided for the respective objects associated with the worker's actions, i.e., the objects including components (many body, component #1, component #2, component #3) and work tools (driver, tweezers, and marker).

Shown in each action field 202 are one or more action bars 203. Each action bar 203 is an image representing a time period during which a corresponding action is performed. More specifically, each action bar 203 extends along a horizontal time axis to a length representing a time period during which a corresponding action is performed. As a result, each action field 202 shows a time series representation of a status of actions associated with a corresponding one of the types of objects.

The action bars 203 differ in the form of display depending on the type of actions, such as an action of holding a component or work tool in the hand, and an action of tightening a screw with a screwdriver. In this example, the action bars 203 differ in the hatching pattern (drawing pattern) depending on the action type. The color of fill in an action bar 203 may differ depending on the action type.

When a user operates the work cycle selection section 106 to select a work cycle, the first action list display section 201 displays analysis results for the entire period of time of one selected work cycle. When a user operates the overall analysis result section 108 to designate a period of time, the first action list display section 201 displays analysis results for the designated period of time.

The first action list display section 201 shows a timeline cursor 204 indicating the current playback position (playback time) of the analysis result video 121 displayed in the video image display section 104. The timeline cursor 204 moves horizontally (along the time axis) with the playback time of the analysis result video 121 in the video image display section 104.

The analysis result details section 107 has a time display section 205. The time display section 205 displays the start time, end time, and time length of a period of time (display period) for the analysis results displayed in the first action list display section 201. When a user operates the work cycle selection section 106 to select a work cycle and the first action list display section 201 displays the entire period of the selected work cycle, the displayed time length represents the work time of the selected work cycle.

When a work mistake (abnormality) is detected, the action field 202 associated with an object (tool, component) related to the detected work mistake is highlighted in the analysis result details section 107. Specifically, the background display format (e.g., fill color, hatching pattern) of the action field 202 is changed. Examples of work mistakes (abnormalities) include an excess of actions, a deficiency of actions, and a change in the order of actions.

When a work mistake (abnormality) is detected, an alert mark 206 is displayed in the analysis result details section 107. An alert mark(s) 206 is displayed in the action field 202 associated with an object(s) related to the detected work mistake, at the position representing the time when the action related to the work mistake is performed. For example, when a detected abnormality is a deficiency of actions, an alert mark 206 is displayed at the position where the action should have been performed. When a detected abnormality is an excess of actions, an alert mark 206 is displayed at the position where the excessive action was performed.

Instead of or in addition to the alert mark 206, an action bar 203 related to a work mistake may be highlighted by a change in the form of display thereof. In some cases, for highlighting, the frame line of an action bar 203 may be depicted in dotted lines, or the transparency of an action bar 203 may be changed, for example.

FIGS. 9(A-1) and 9(A-2) are examples of actions associated with the component #3. In this case, a component handling work consists of an action of holding the component by hand. In a worker's work procedure shown in FIG. 9(A-2), the action of holding the component by hand is excessive one time compared to the regular work procedure shown in FIG. 9(A-1), which is detected as a work mistake (abnormality) and an alert mark 206 is displayed.

FIGS. 9(B-1) and 9(B-2) are examples of actions associated with a screwdriver. In this case, a screw-tightening work consists of actions of holding a screwdriver by hand, picking a screw from a parts box, and tightening the screw. Specifically, a set of actions of picking the screw from the parts box and tightening the screw is repeated three times. In the worker's work procedure shown in FIG. 9(B-2), the actions of picking the screws from the parts box are one less than the normal work procedure shown in FIG. 9(B-1), which is detected as a work mistake (abnormality) and the alert mark 206 is displayed.

FIGS. 10(A-1) and 10(A-2) are examples of actions associated with a marker. In this case, a marking work consists of actions of holding the marker by hand, opening a cap, making a mark, and closing the cap. In the worker's work procedure shown in FIG. 10(A-2), the action of closing the cap is missing compared to the normal work procedure shown in FIG. 10(A-1), which is detected as a work mistake (abnormality), and the alert mark 206 is displayed.

As shown in FIG. 11, when a work mistake (abnormality) is detected, an abnormality display section 211 may be displayed in the analysis result details section 107. The abnormality display section 211 displays a text indicating a detected work mistake. In this example, the abnormality display section 211 displays one excess action associated with the component #3, one less screw tightening as an action associated with the driver, and a missed cap closing as an action associated with the marker.

As shown in FIG. 12, the overall analysis result section 108 has a second action list display section 301. The second action list display section 301 visualizes results of long-term analysis of statuses of the actions associated with the respective objects to present the visualized results to the user. In the first action list display section 201, action fields 302 extending horizontally are provided in a row for respective types of objects associated with actions of a worker. In each action field 302, action bars 303 are shown as in the first action list display section 201.

The second action list display section 301 shows analysis results for a period of time designated by a user's operation on the period designation section 103 (target period).

The overall analysis result section 108 includes a slider bar 304. The slider bar 304 allows a user to operate left and right sliders 305 to thereby designate a time period for the analysis results to be displayed in the analysis result details section 107. The left slider 305 and the right slider 305 are used to set a start time and an end time, respectively. As a user designates a time period in the overall analysis result section 108, the analysis results for the designated time period are displayed in the analysis result details section 107, expanded in the direction of the time axis.

When a user selects a work cycle by operating work cycle selection section 106, the left and right sliders 305 move to the positions corresponding to the times (start and end times) that determine the period of the selected work cycle, and analysis results for the selected work cycle are displayed in the analysis result details section 107.

When a work mistake (abnormality) is detected, the overall analysis result section 108 displays a count mark 306. The count mark 306 indicates the number of work mistakes (anomalies) detected in one work cycle. The count mark 306 is displayed in an area of a work cycle in which work mistakes were detected. In this example, count marks 306 indicate that one work mistake was detected in the work cycle #1 and three mistakes in the work cycle #4.

When an abnormality in a work cycle is detected, the work cycle related to the detected abnormality is highlighted in the overall analysis result section 108. Specifically, a rectangular image 307 is displayed to indicate the work cycle. The rectangular image 307 is highlighted with a fill color or a hatching pattern, for example. In this example, abnormalities are detected in the work cycle #4. Examples of abnormalities in a work cycle include cases where a time period of a work cycle is longer or shorter than a standard time period and the difference between the actual time period and the standard time period of work cycle is greater than a predetermined amount of time.

As shown in FIG. 13, in the overall analysis result section 108, the time period designated by the slider bar 304 (i.e., the time period for which the analysis results are displayed in the analysis result details section 107) is highlighted. Specifically, a rectangular image 311 is displayed to indicate the designated period of time. The rectangular image 311 is highlighted with, for example, a fill color or a hatching pattern. The rectangular image 311 is displayed in a different form from the other rectangular image 307, which is highlighted to indicate a work cycle in which abnormalities are detected, such that the rectangular image 311 is distinguishable from the other rectangular image 307. In this example, the work cycle #5 is selected and the rectangular image 311 is displayed for the work cycle #5.

Thus, in the present embodiment, the period designation section 103 allows a user to designate the period of time (target period, first period) for which analysis results are displayed in the overall analysis result section 108. In addition, the slider bar 304 allows a user to designate the period of time (part of the target period, second period) for which analysis results are displayed in the analysis result details section 107. Furthermore, the work cycle selection section 106 allows a user to show the analysis results for one work cycle in the analysis result details section 107.

The first period for which analysis results are displayed in the overall analysis result section 108 is a target period designated within the entire period during which the work is performed by a worker, and the second period is part of the target period designated as a period of time for which analysis results are displayed in the analysis result details section 107. In other words, the analysis result details section 107 and the overall analysis result section 108 differ in their time scale, such that part of the analysis results displayed in the overall analysis result section 108 is displayed in the analysis result details section 107, expanded in the direction of the time axis. This set of sections allows a user to view the first analysis result display information to obtain a bird's eye view of the worker's work performance status over a wide period of time, and also view the second analysis result display information to check details of the work performance status of the worker.

In one example of a procedure of user's operations, first, a user operates the work cycle selection section 106 to designate a work cycle and views the analysis results for the selected one work cycle displayed in in the analysis result details section 107, and then the user operates the slider bar 304 to select any time period for which analysis results are displayed in the analysis result details section 107 to thereby view the analysis results for the selected time period. In this case, the user can operate the slider bar 304 to select any time range of interest within one work cycle to view analysis results for the selected time range. In some cases, the user can operate the slider bar 304 to select a time range that spans two or more work cycles to view analysis results for the time range displayed in the analysis result details section 107. In addition, the analysis of work performance status described above is applicable to any work in each process step in a factory, and also applicable to any work performed regularly in various facilities outside of a factory (such as work of loading/unloading of products, work of cleaning, or a patrol security work).

While specific embodiments of the present disclosure are described herein for illustrative purposes, the present disclosure is not limited to those specific embodiments. Various changes, substitutions, additions, and omissions may be made to elements of the embodiments without departing from the scope of the present disclosure. Moreover, elements and features of the different embodiments may be combined with each other to yield another embodiment of the present disclosure.

### INDUSTRIAL APPLICABILITY

A work analyzing device and a work analyzing method according to the present disclosure, in which operations are performed to analyze and visualize a worker's actions forming a work, in association with an object (a target object) handled by the worker such as a component or a work tool, have an effect of enabling a user to easily grasp a work performance status of the worker in more detail, and are useful as a work analyzing device and a work analyzing method in which a processor is caused to perform operations to output analysis result information on a work performance status of a worker based on video recordings of actions of the worker.

### GLOSSARY

1 camera
2 recorder
3 server (work analyzing device)
4 administrator terminal
11 video input device
12 screen output device
13 storage
14 processor
101 analysis result display screen
102 process selection section
103 period designation section
104 video image display section
105 playback menu section
106 work cycle selection section
107 analysis result details section
108 overall analysis result section
141 work cycle button
201 first action list display section
202 action field
203 action bar
204 timeline cursor
206 alert mark
211 abnormality display section
301 second action list display section
302 action field
303 action bar
304 slider bar
305 slider
306 count mark

1. A work analyzing device in which a processor is caused to perform operations to output analysis result information on a work performance status of a worker based on video recordings of actions of the worker,
wherein the processor is configured to:
based on the video recordings, recognize one or more target objects to be handled by the worker and determine types of the target objects, while recognizing one or more actions of the worker, the actions forming a work, and determining types of the actions; and
output analysis result display information which visualizes the analysis result information, and is a time series representation of a status of the actions associated with each of the types of the target objects.

2. The work analyzing device as claimed in claim 1, wherein the processor outputs the video recordings as a video image that allows for playback, in association with the analysis result display information.

3. The work analyzing device as claimed in claim 1, wherein the processor identifies at least one of a component or a work tool as the type of the target objects.

4. The work analyzing device as claimed in claim 3, wherein the processor identifies at least one of an action of holding a component and an action of using a work took as the type of the actions of the worker.

5. The work analyzing device as claimed in claim 1, wherein, when detecting an abnormality in the work performance status of the worker, the processor outputs the analysis result display information that includes information on the detected abnormality.

6. The work analyzing device as claimed in claim 5, wherein the analysis result display information includes, as the information on the detected abnormality, at least one of
a highlighted display of fields for the recognized target objects,
a display of a mark indicating a corresponding one of the actions associated with the abnormality,
a display of a text indicating the detected abnormality, and
a display of statistical information including a set of statistics collected over a prescribed period of time included in a period of time designated for the analysis result information.

7. A work analyzing method for causing a processor to perform operations to output analysis result information on a work performance status of a worker based on video recordings of actions of the worker, the operations comprising:
based on the video recordings, recognizing one or more objects to be handled by the worker and determining types of the target recognized objects, while recognizing one or more actions of the worker, the actions forming a work, and determining types of the actions; and
outputting analysis result display information which visualizes the analysis result information. and is a time series representation of a status of the actions associated with each of the types of the objects.
